(19) United States
(12) Patent Application Publication
(10) Pub. No.: US 2006/0111929 A1
(43) Pub. Date: May 25, 2006

(54) Method and system for optimizing use of shipping containers

(76) Inventors: David Bruce Poole, Chesapeake, VA (US); Eric George Bey, Chesapeake, VA (US); Shane Bouchard, Virginia Beach, VA (US); Ernest Sammons, Norfolk, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 11/283,975

(22) Filed: Nov. 21, 2005

Related U.S. Application Data
(60) Provisional application No. 60/629,763, filed on Nov. 20, 2004.

(51) Int. Cl. G06Q 99/00

(52) U.S. Cl. 705/1

(57) ABSTRACT

A network-based application enables participants to “street-turn” or “road-turn” ocean containers amongst themselves with ease and minimal liability exposure. A database that includes both static and dynamic memory is provided for storing information relating to each container. By interfacing with this database, participants may search for specific criteria relating to a unique container that meets the desired loading specifications of the searching participant. When found, the searching participant may contact the current user of the container to arrange for transfer of the container to the searching participant. Thus, a virtual container pool is created wherein a container may be located anywhere and usage rights and liability of the container may be transferred between participants.

The present invention claims priority from U.S. Provisional Patent Application Serial No. 60/629,763 filed on Nov. 20, 2004.

The subject matter of the present invention did not receive federal government research and development funding.

### BACKGROUND OF THE INVENTION

The present invention relates generally to a system and method for transferring control, liability and usage of a shipping/cargo container, chassis and/or trailer between different participating parties, such as motor carriers. More particularly, the invention relates to a business method and inventory tracking system for transferring control of a shipping container, chassis and/or trailer that is remote from a depot such as a marine terminal or railway head. Each participant may easily reassign responsibility and usage rights of a container, chassis, or truck trailer to another participating party to optimize usage of the container. Thus, the invention facilitates transferring usage of a container, trailer and/or chassis without returning it to a storage area. Throughout the application the terms, container, trailer and chassis are used interchangeably and are collectively referred to as shipping devices.

Marine terminals, ports, depots or container staging areas import shipments of goods that must be offloaded and/or directed towards remote points-of-destination. Many goods arrive in ocean going shipping containers, are offloaded onto a trailer, and pulled to a warehouse, depot or other storage area. When the goods are removed from the container or trailer, the empty container or trailer is typically returned to the staging area for reuse in delivery of other goods. Usually, the container or trailer is returned to the staging area empty of any goods. Returning an empty shipping container or trailer is inefficient, contributes to noise and air pollution and is a waste of valuable time, resources and money.

A container yard is a physical location where containers/chassis' are stored. Much of the work performed at a container yard is paperwork or electronic tracking necessary for tracking usage of the containers/chassis'. Containers are stored, maintained, and interchanged at two principal staging areas or locations: the container yard, and the off-dock container depot. Marine terminal container yards are part of a port terminal complex and operated by marine terminal operators on behalf of ocean carriers. Container depots are usually owned and operated by separate, specialized firms. Roughly one-half of all containers are owned by leasing companies. These containers are leased to ocean carriers under leases that spell out rates, quantity of containers leased, and procedures for leasing more containers or returning unneeded containers.

Staging areas provide empty containers/ trailer chassis' to exporters who load the containers and return them to the container staging areas. In each instance, an empty container is either returned to the staging area or drawn from the staging area which results in an inefficient use of the container or trailer chassis during one way of the import/export process. It is advantageous to “street-turn” the containers, chassis' and/or trailers by transferring or reassigning the usage rights between different parties without returning to the area from which the container/chassis/trailer was originally transported. The term “street-turn” should be interpreted broadly to include, but not be limited to, transferring use, control and/or responsibility of an empty container, trailer or shipping device between participating parties remote from the staging area. Participating parties may include ocean carriers, motor carriers, depot operators and the like. Interchanges may occur between ocean carriers and motor carriers, between motor carriers and depot operators, and between different motor carriers or the like.

Previously, the task of “street-turning” containers/trailers/chassis' between different motor carriers was difficult to achieve. This task was achieved by informally transferring responsibility of the container/chassis between the different motor carriers. It was difficult to reset “free” or down time of the container/chassis which typically lead to one motor carrier being incorrectly assessed a per diem charge for using the container/chassis/trailer for an excessive amount of time. Thus, coordinating the street-turning of a container/chassis/ trailer was difficult. Street-turning of the container/trailer/chassis, (shipping device) was based on an honor system between motor carriers or other participants. Damages and/or per-diem charge backs for use of the container/chassis for more than allotted time were handled informally on a case-by-case basis. Thus, the system was not uniform and resulted in chaotic results.

To move a container over a highway, the container must be mounted onto a chassis, a specialized trailer with fittings for securely mounting the container. Chassis logistics are a major limitation in transporting empty containers. Even when an ocean carrier has no immediate need for a specific empty container to be returned; there may be a pressing need to use the chassis for another container movement. Containers and/or trailers are stored in a staging area, depot or container yard. Numerous trips are typically required to move containers between different parties such as motor carriers and the like. These numerous trips contribute to air pollution emission problems, as well as traffic congestion. Thus, there is a great need for more efficiently transferring control of containers and/or trailers between participating parties.

Several factors that limit transferring containers and/or trailers between participating parties are import/export timing or location mismatches, ownership mismatches, specification mismatches, off-hiring of leased containers and lack of incentives for participating parties. The present invention overcomes all of the aforementioned problems.

### SUMMARY OF THE INVENTION

The present invention is a network-based application that enables participants, such as motor carriers, draymen and the like, to “street-turn” ocean containers and/or trailers among themselves with ease and minimal liability exposure. By interfacing with the ocean terminals and/or ship-lines computerized data stored in a database, the application provides participating motor carriers with a list of all ocean containers that were interchanged off-terminal under their standard carrier alpha code, “SCAC”, along with a “loaded” status. In one instance, a motor carrier or other participant hauls a load of goods from a centralized location where goods are offloaded and temporarily stored. The motor carrier arrives at the centralized location, assumes control and responsibility of the goods which are being hauled in a shipping device, and pulls the shipping device to a delivery location such as a retail store or warehouse. Once the goods have been emptied from the shipping device, a motor carrier or other participant confirms the emptying of a delivered container. Thereafter, the motor carrier may “post” the empty container in a “virtual container pool” with an electronic input device by changing an availability data field in a database. The electronic input device may include one or more of a microprocessor, global positioning device, keyboard, mouse, personal digital assistant, “PDA”, telephone or the like. It is contemplated that additional electronic input devices may be utilized.

The virtual container yard is a place where information relating to containers/chassis' is stored for interchanging among participants. The necessary forms are completed via electronic means. It performs to allow posting of specific information while serving as a conduit for communications among participants. The virtual container yard facilitates good decision making by preventing unnecessarily dispatching trucks. The information provided in a database associated with the virtual container yard assists draymen in exploiting opportunities.

The key purpose of the virtual container yard is to post needed information about shipping devices such as containers, trailers and chassis' such as status, location, etc. It facilitates communication between parties such as motor carriers, ocean carriers, leasing companies, chassis pool operators, etc. The virtual container yard also permits equipment interchange and other processes to take place without physically moving the container/chassis to the harbor. Lastly, the virtual container yard assists parties to make optimal decisions regarding container logistics such as return, reuse, interchange and the like, as well as rationalizing moves and planning ahead.

In the preferred embodiment, any participating party or motor carrier can view this “virtual container pool”, using a microprocessor-based system to sort between the posted containers/trailers/chassis' for specific search criteria to identify a desired container that satisfies the specific search criteria and loading requirements within the database. If a match is found, the “searching” participant or motor carrier can contact the participant or motor carrier that posted the container/trailer and arrange for transfer of use and responsibility of the container/trailer. The posting participant may inform the searching participant of the geographic location of the container and condition of it.

If the searching participant assumes responsibility for the liability of the container/trailer, then the status of the container/trailer is changed to reflect such a change in the database. The ocean terminal's records and/or a ship-lines' records are periodically updated to indicate the status, location, etc. of the container/chassis/trailer.

The invention is realized by first creating a database including fields relating to a plurality of containers, trailers and chassis'. This data may include data relating to specifications of each such as length, width, weight, fitting types, storage container type, chassis type, serial number etc. This information is accessed by a participating party who chooses one of the containers and/or chassis'. The container/chassis is flagged as being in use or removed from the “available” database. The container is loaded and delivered to a destination. Thereafter, the container is unloaded.

The motor carrier may then post the container as being available for pickup by another motor carrier. This is achieved by creating a virtual container storage table that includes a dynamic memory that may be changed to reflect that the container is available. The “posted” container may be viewed by other motor carriers who may enter search criteria to readily identify a unique container or chassis. The searching motor carrier may then contact the “posting” motor carrier and arrange for control, responsibility and use of the container/chassis to be transferred from the posting party to the searching one. The information may then be updated in the central controller to indicate where the container/chassis is located and its intended purposes of use.

It is an object of the invention to provide a software process that allows for a transfer of liability and usage rights between participants remote from a storage area. The participants may be remote from one another and may only communicate between themselves using electronic communications such as telephones, facsimiles, electronic mail, instant messaging and the like.

It is another object of the invention to provide a process for updating an ocean terminal's, ship line's, railroad's or port's record to reflect that a container or chassis has been interchanged off terminal as “empty” by the “receiving” motor carrier. This process allows transfer of responsibility for the container and resets the container's off-terminal “free-time” as indicated in each motor carrier's individual interchange agreement.

It is a further object of the invention to lower operating costs and increase revenues for participating motor carriers by making daily operations of the participating motor carriers more efficient. The process also eliminates liability exposure commonly associated with the “street-turning” of containers between different motor carriers. An additional benefit is the minimization of manually entered data inputted by participating motor carriers.

It is an additional object of the invention to provide a virtual container pool that allows participants to post empty containers without manually entering data relating to the container. The container is posted within a database for allowing other participants using specific search criteria to search and select the container.

It is further object of the invention to provide a unique process for interchanging containers between ocean carriers and motor carriers, motor carriers and depot operators and between two motor carriers.

These and other objects of the invention and advantages of the invention will be set forth, appear in part or become apparent after considering the specification and accompanying drawings. It is to be realized that the following embodiments of the invention have been represented in their simplest form for ease in understanding the invention.

### BRIEF DESCRIPTION OF THE DRAWINGS

FIG. 1A is a block system diagram of a first embodiment of the invention.

FIG. 1B is a block system diagram of a second embodiment of the invention.

FIG. 2A is a database table for storing various information relating to the method for carrying out the invention.

FIG. 2B is a database table that includes static and dynamic fields containing information relating to containers and chassis'.

FIG. 3 is a block diagram of the central processor for controlling a method of interchanging shipping containers between two participating parties.

FIG. 4 is a smaller scale view of a flowchart representing a preferred method of carrying out the invention. FIGS. 4A thorough 4E are various parts of the flowchart shown in FIG. 4. Each drawing connects with its respective preceding and subsequent drawings as shown in FIG. 4.

FIG. 5 is a diagram representative of a flow of containers, chassis' and trailers that may occur.

FIG. 6 is a prior art transactional method for using containers.

FIG. 7 is a transaction method for street-turning a container and/or trailer and optimizing use of the container and/or trailer.

### DETAILED DESCRIPTION OF THE INVENTION

The following is the preferred embodiment or best mode for carrying out the invention. It should be noted that this invention is not limited by the discussion of the preferred embodiment and should only be defined by the appended claims.

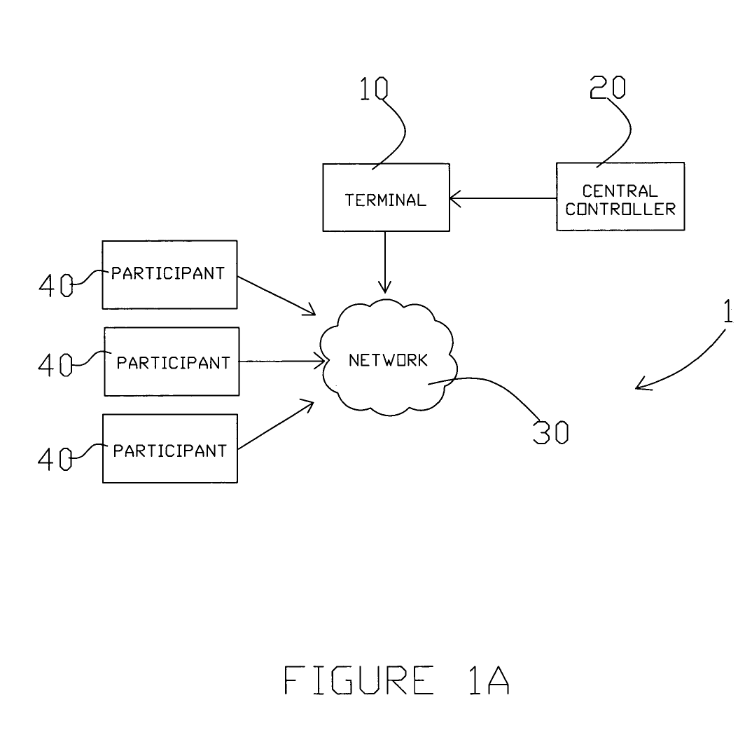

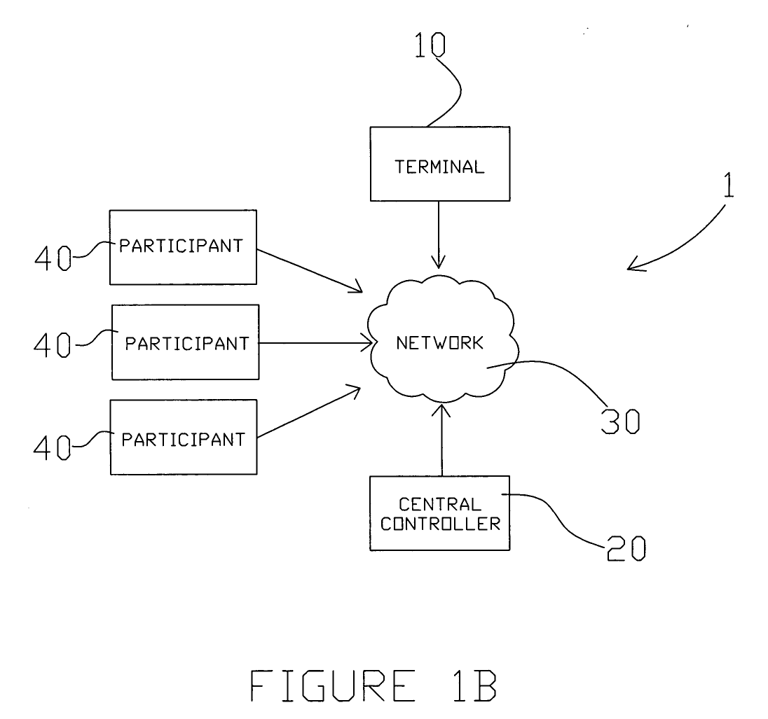

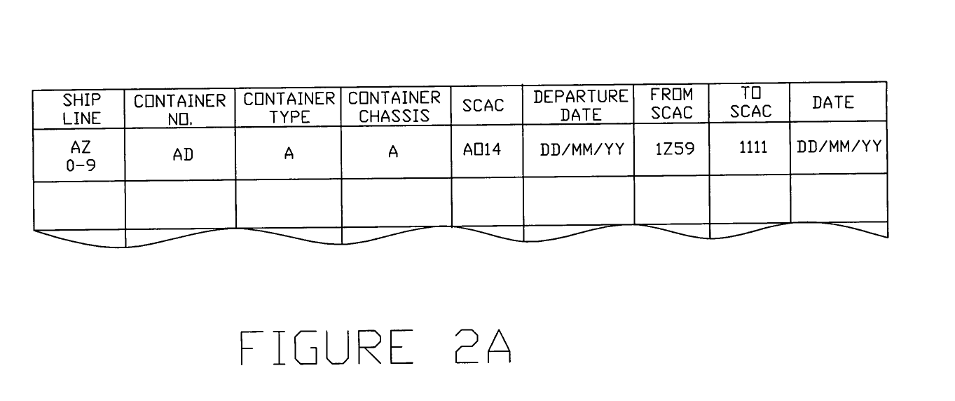

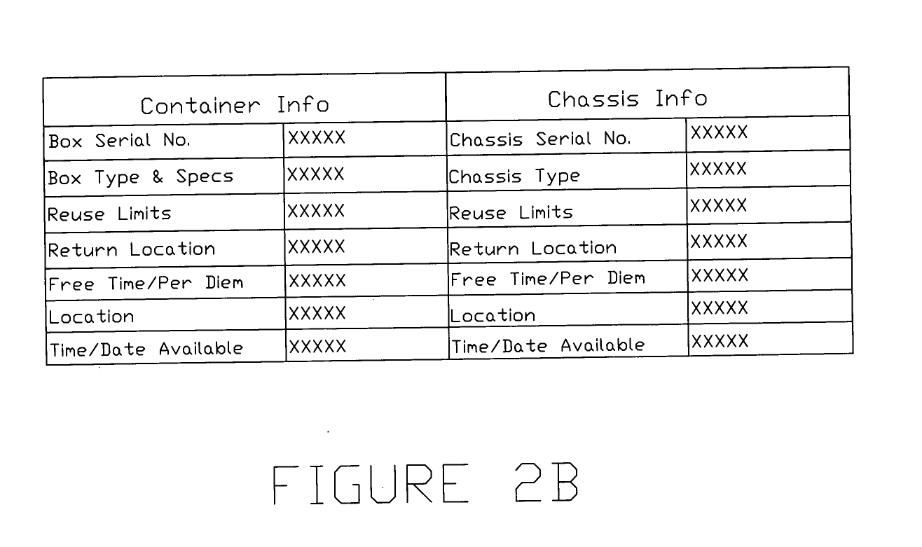

FIGS. 1A and 1B depict two embodiments of the system 1 for implementing the present invention. The system 1 includes a network 30 to which a terminal 10 and a plurality of participants 40 are connected. In FIG. 1A, a central controller 20 connects directly with the terminal 10 and may be located within terminal 10. Thus, any information flowing to and from the central controller 20 must pass through the terminal 10. Terminal 10 is typically defined as a freight station that is central to a considerable area or serves as a junction at any point with other transportation lines. This may include a port, harbor, railhead, and the like. Terminal 10 may comprise a series of piers, offloading equipment, container berths, storage areas, warehouse complexes, railroad tracks and the like. The participants may include, but not be limited to, movers of products and goods such as motor carriers, draymen, trucking firms, warehouse facilities, importer, exporters, railroad operators, container depot operators, consignees, shippers and the like. Terminal 10 may comprise a computer or a plurality of computers that connect to the central controller that stores a plurality of databases indicating the status of various shipping devices. Each participant 40 includes an electronic device, preferably a computer, connected to the network 30.

In FIG. 1B, the central controller 20 is remote from the terminal 10. Controller 20 is controlled by a third party and connected to the terminal 10 via the network. In both instances, the participants and the terminal operators may view, update, and change information relating to specific information such as usage dates, loading status, availability for use, user codes and the like depending upon user status of each. The network may comprise the world wide web, other such internet network, or a private network, that through a link which may be a telephone line, an ISDN line, modem line or any such other network connection, allows data communications between a network and a participant. The network may be interfaced through use of telephones, personal digital assistants, facsimiles, text messaging devices, Web-TV devices, screen-phones or any appropriate device to communicate with the central controller. Thus, the system may comprise a microprocessor-based network for empowering participants with greater flexibility in selecting, using and transferring usage of a container/chassis/trailer between different participants. The network may include a limited access website that may be accessed through a password, unique user identifier or the like.

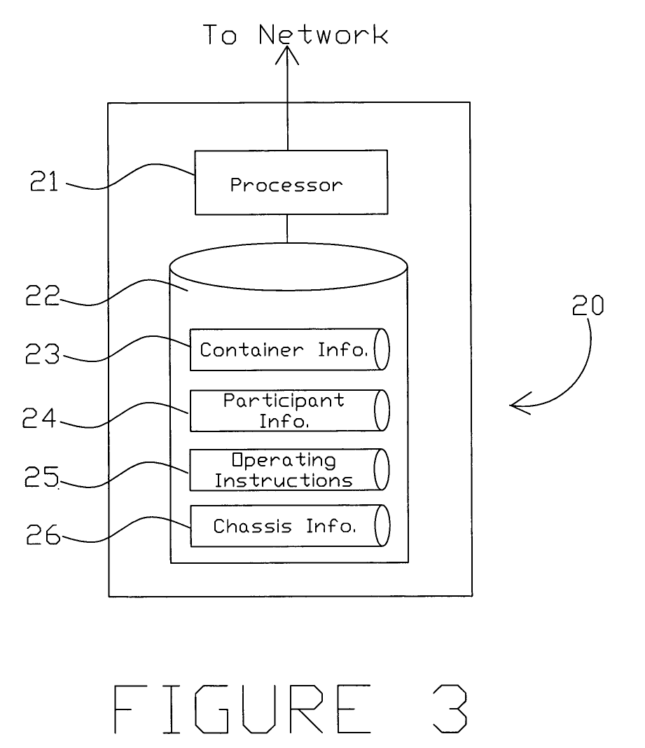

FIGS. 2A and 2B depict two database tables that may be utilized for implementing the invention. These databases are typically located in the central controller 20 but may be located in any computer that is controlled by the terminal operators. FIG. 2A includes fields that comprise both static and/or dynamic information. In FIG. 2A, the database includes a unique identifier for each shipping line. Typically, this identifier is a two position character comprising letters or numerals that identifies each shipping line.

Information relating to each shipping/cargo container owned or controlled by the terminal or other participant is provided in the database. This information may include, but is not limited to, a container number that relates to a specific container. The container number may comprise an eleven digit identifier comprising letters or numerals and may be the serial number of the container.

Information relating to the container type is also provided in a unique identifier. For example, the container type identifier may identify the type of container. The various types of containers may include, but not be limited to, a dry freight container, a refrigerated container, an insulated container, a flat rack container, an open top container or a high cube container. Each type of container includes a unique identifier relating thereto.

A unique identifier relating to the chassis type necessary for hauling the container type may be provided in the database. This information may indicate whether a standard chassis, high payload chassis, custom chassis or the like is necessary for transporting the container. An SCAC code or identifier relating to a participant that is currently using the container may also be provided in the database. If no participant is utilizing the container, then this identifier may be left blank or an identifier that is unique to the terminal, depot or storage area may be utilized.

The departure date indicating the date that the container was hauled from a storage area, terminal or depot may be provided, as well as the SCAC code indicating the departure point and the destination may also be provided. The projected date of arrival at the destination may also be provided, as well as the time and date when the information in the system was last updated.

FIG. 2B depicts a database table that comprises container information and chassis information. This database comprises both static and dynamic information. The static information is entered when a container, chassis or trailer is placed into service with the terminal or participant. This information may include serial numbers, type, specifications, reuse limits and return location. The dynamic information may include free time/ per diem for overages of time, location of the container/chassis/trailer, as well at the projected time and date of availability. The databases of FIGS. 2A and 2B may be combined into a single database or maintained separately for practicing the invention. Data entered into either database may be viewed by a participant. Alternatively, viewing of the data may be limited to those containers that are either under the control of the participant or listed in the database being available. The dynamic information shown in FIG. 2B may be used by the central controller to determine whether the shipping device is available. For example, a participant who is in control of a particular shipping device may change the time/date available to reflect that the shipping device is now available. The central controller may then consider the shipping device as being posted and allow others to view its specifications and gain control as later discussed. Moreover, either of the databases may include a booking number identifying the organization, customer, freight type, and further identifying specifications, container number and other indicia. This booking number may be used as a cross check or backup for tracking the shipping device.

FIG. 3 is a preferred embodiment of the central controller 20 that controls the process. The central controller 20 comprises a processor 21 and a data storage system. The processor is conventional and a computer system adapted to run software programs and that is configured with communications equipment such as Internet connection and telephony equipment. The data storage system 22 is preferably any form of mass storage device configured to read and write data in a file storage device, e.g. magnetic or optical data storage devices. It should be noted that the data storage system may be one that comprises multiple disk sub-systems that may be geographically dispersed and coupled via network architecture. The processor and data storage system are coupled via a link that may include a bus or network architecture.

Stored within the data storage system are database tables forming a database management system maintained by the central controller 20. In particular, the data storage system 22 may include database tables shown or previously mentioned above. In the preferred embodiment, the data storage system includes a table on container information 23, participant information 24, operating instructions 25, and chassis information 26. The processor controls access to the data storage system 22 and may limit access to information through passwords or the like. Moreover, the processor may limit one's access to certain data or a user's authority and/or authorization. Access may also be limited to others if the container or chassis' is not “posted” as being available. A posting page is maintained by the controller for listing available shipping devices that may be street-turned.

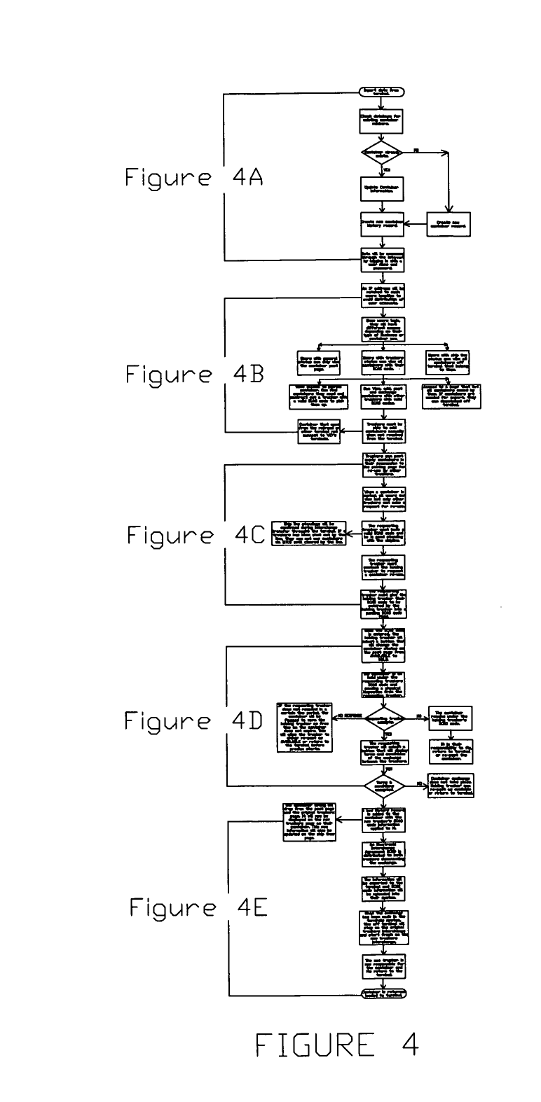

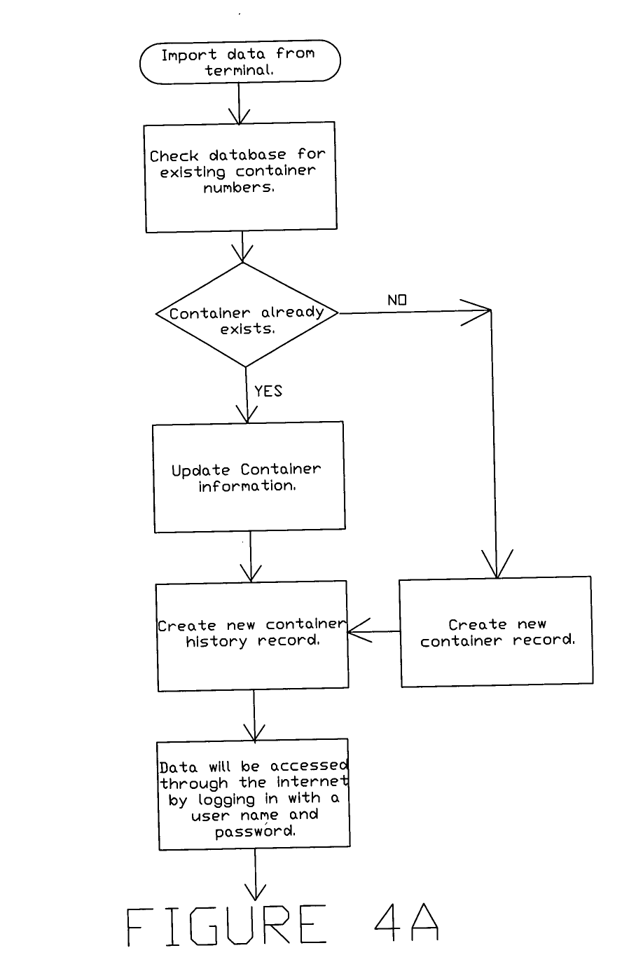

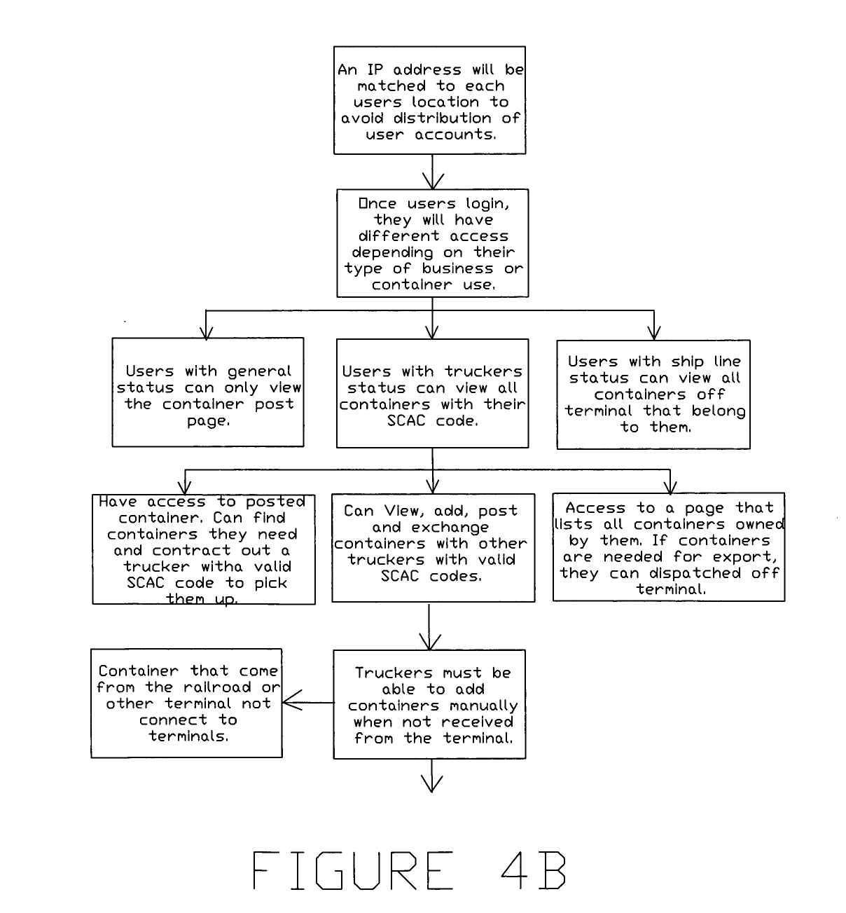

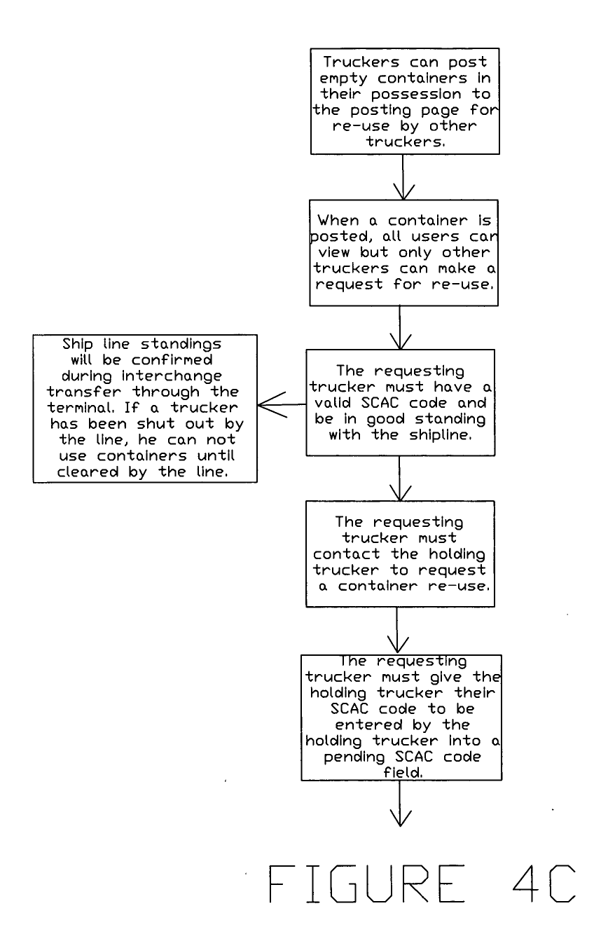

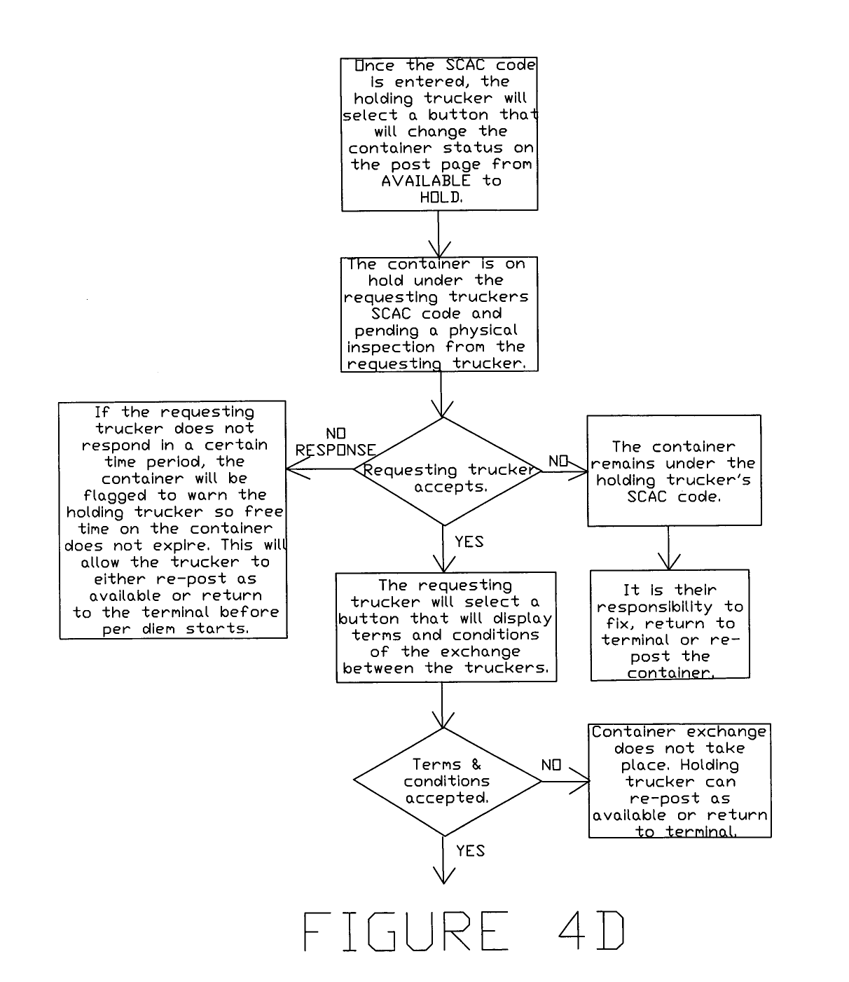

FIG. 4 is a flowchart depicting the preferred embodiment for carrying out the invention. In FIG. 4A, data relating to each container is entered into a database by an operator at the terminal, storage depot or the like. This information is then imported into the central controller. If the central controller is maintained by the terminal, then it is unnecessary to import the data. The database is then checked to determine whether a record of the container exists, if the container is not in the database, then a new record is created. Otherwise, the container information is updated in the database to reflect any changes in the dynamic memory mentioned above. This updated information is used to create a new container history record.

Participants are then allowed to access the information relating to each container record via the internet or other network using a unique identifier such as a user name and password. An internet protocol (IP) address is assigned to each participant. This IP address is matched to each participant's location to prevent unauthorized viewing of each participant's account.

Each participant is assigned a level of access depending upon their type of business or container use. For example, participants having a general access status can only view a database or webpage that lists the containers posted for assignability and use. Users, such as motor carriers, trucking firms, draymen and the like can view the posted containers as well as their account information and all of the container listed as being assigned to their SCAC code. Shipping line users and the like can view the location of all containers that are owned or controlled by them and the location of each.

Users, such as motor carriers, trucking firms, draymen and the like have access to posted containers and search features such that searches of the database may be performed to quickly list “posted” containers having unique loading specifications. They can contract with others having valid SCAC codes who have posted containers to assume control of the containers. The truckers can view, add, post and exchange containers with others. They are provided access to a page that lists all containers owned or controlled by them. If containers are needed for export, they can be dispatched to a specific location.

Containers may be manually entered into the database by motor carriers, trucking firms, draymen and the like, collectively referred to as “truckers”, when the containers are hauled from other locations not affiliated with the terminal. Some of these may include warehouses, railroads and the like. The truckers can post empty containers in their possession to the posting page for re-use by other truckers. Only truckers having a valid SCAC code and in good standing with the ship lines are allowed to accept posted containers. When a trucker requests usage rights to a container, the SCAC code of the trucker is reviewed to determine whether the trucker is in good standing with the ship lines. If the trucker is not in good standing, the transfer of usage rights will be flagged and no transfer will occur until the trucker is cleared through the ship line.

The requesting trucker contacts the posting trucker and request re-use of the container. The requesting trucker provides the posting trucker with their SCAC code to be entered by the posting trucker into a pending SCAC code field. After the SCAC code is entered, the posting trucker selects a transfer option that changes the container from posted to hold. The container is held under the requesting trucker's SCAC code until the requesting trucker conducts a physical inspection of the container.

The requesting trucker can then can accept control of the container. The requesting trucker has a specified period of time to inspect and accept control of the container. If the requesting trucker fails to accept the container within this period of time, the container is flagged to warn the posting trucker to avoid free time on the container from becoming expired. The posting trucker may then repost the container or return it to the terminal before a per diem begins.

If the requesting trucker rejects the container, the container remains under the posting trucker's SCAC code. It is the posting trucker's responsibility to fix, return or repost the container. If the requesting trucker accepts responsibility of the container, then terms and conditions relating to the transfer are displayed. The requesting trucker may then decline accepting the transfer; in which case, the posting trucker can repost or return the container to the terminal.

If the requesting trucker accepts the terms, a new history record is added to the container reflecting the accepting trucker's SCAC code. The container listing is dropped from the container posting page and displayed on the accepting trucker's page as being in their control. This information is automatically updated on the ship lines page. An electronic interchange agreement is issued to both the receiving and posting truckers. The information is relayed to the terminal and updated on their system. After the exchange has been made, time off terminal for the posting trucker is stopped. A new time off terminal is started for the receiving trucker. The new trucker now assumes full liability and usage rights to the container. The container is then loaded and used as necessary to be eventually returned to the terminal.

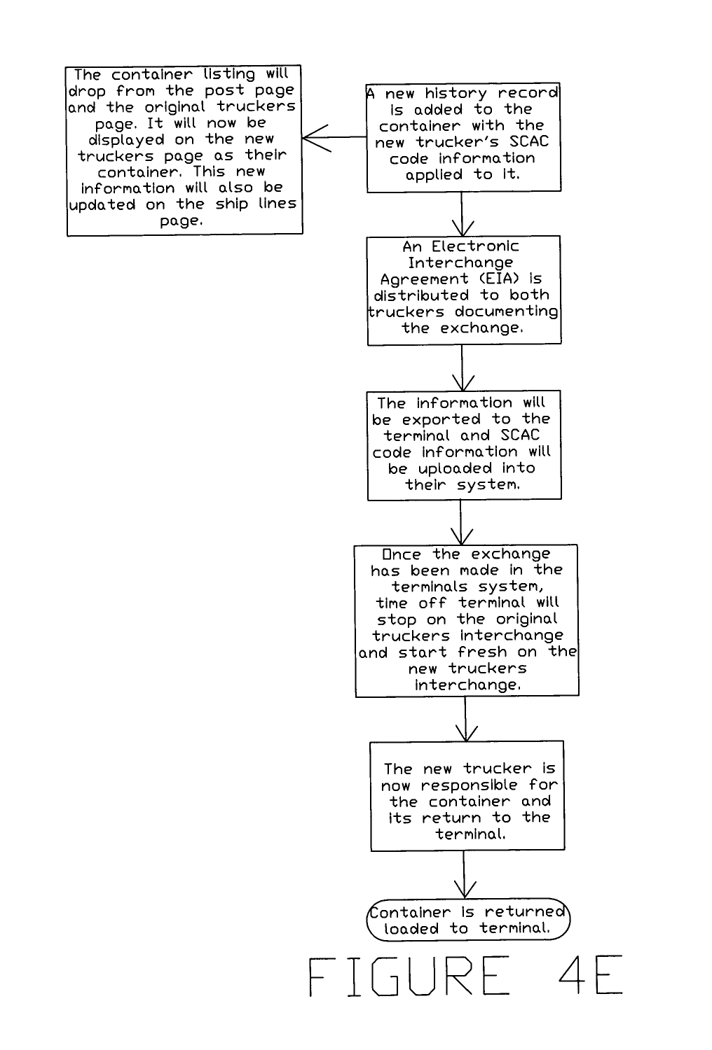

FIG. 5 is an example of a typical flow of containers between different parties. Import loads 70 and export loads 71 are directed towards and away from terminal 70. Import loads 70 are also directed to the rail terminals 11, container depots 12, local consignees 14 and local shippers 13. As can be seen in this example, inefficient use of empty containers 72 is prevalent in all aspects of shipping between the parties.

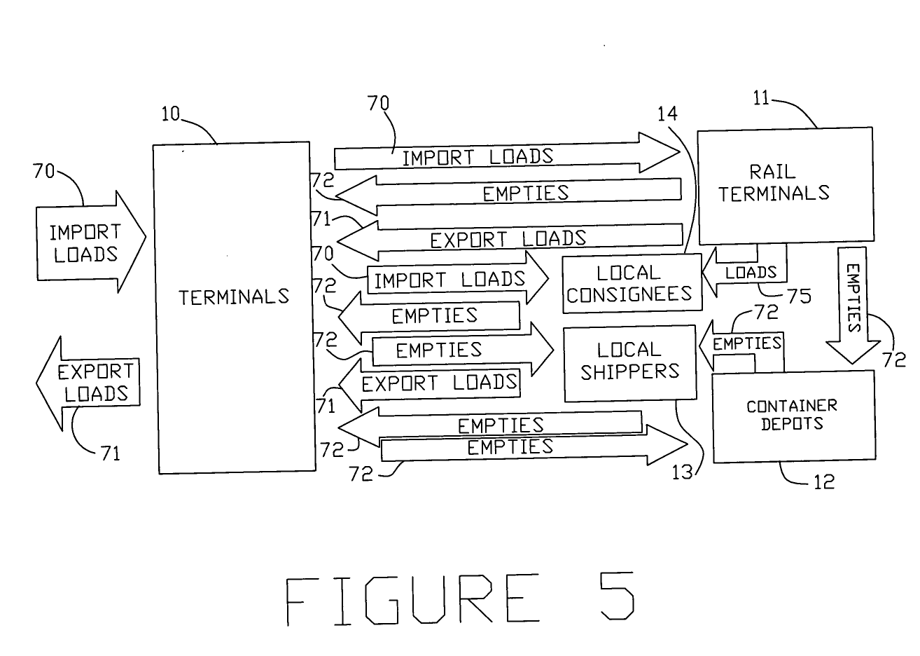

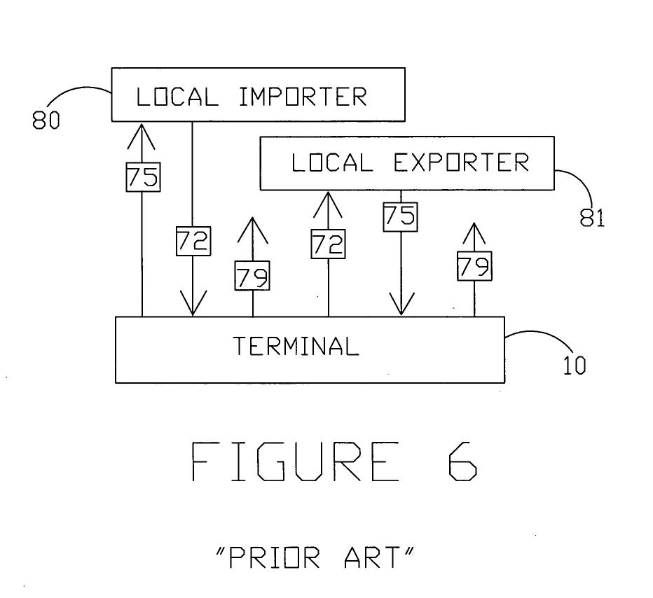

FIG. 6 is an example of a current empty return system. A loaded import container 75 is hauled to a local importer 80. This importer 80 unloads the container and the empty container 72 is returned to the terminal 10. The truck is then bobtailed without a trailer 79 to its next destination. An empty container 72 is then hauled to a local exporter 81 and loaded with goods to be exported. The loaded container 75 is then returned to the terminal 10, whilst the truck is driven to its next destination 79.

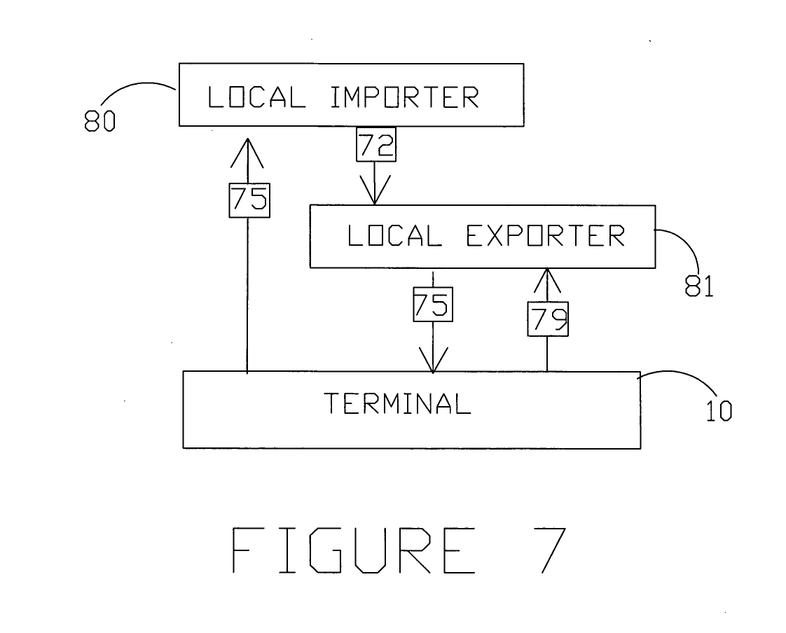

FIG. 7 depicts the more efficient use of containers as provided by the present process and system. In this instance, the loaded container 75 is driven to the local importer 80. The importer unloads the container and the unloaded container 72 is then moved to a local exporter 81 without returning it to the storage yard by road-turning it. The exporter 81 loads the container and the loaded container 75 is returned to the terminal 10. The truck is then driven to its next destination 79. As can be seen, the present system and process provides a more efficient use of containers by allowing participants to road-turn the shipping devices.

It is to be understood that the invention is not limited to the exact construction illustrated and described above. Various changes and modifications may be made without departing from the spirit and the scope of the invention as defined in the following claims.

We claim:

1. A computer system for transferring control, liability and usage of a shipping device that is remotely located from a staging area between different participating parties, said system preventing an inefficient use of the shipping device by allowing participating parties to street-turn a shipping device, said system comprising:
a central controller comprising at least one database having a plurality of data fields, at least one of said data fields including identification indicia for each shipping device comprising a first informational data field for individually identifying each shipping device and at least one of said data fields including an availability status of each shipping device;
a network connected to said central controller for allowing access to the at least one database;
a plurality of participants connected to the central controller for manipulating the at least one of said fields including an availability status of each shipping device.

2. The computer system of claim 1 wherein said central controller comprises a plurality of instructions that allow one or more of said participants to search the at least one database for specific search criteria to identify a desired shipping device that satisfies the specific search criteria.

3. The computer system of claim 1 wherein said plurality of participants comprises at least searching participants that are searching for a shipping device that satisfies a specific search request and posting participants that list at least one shipping device in said database as being available for use by another participant.

4. The computer system of claim 1 wherein said database further comprises data fields describing one or more selected from a group consisting of shipping containers, trailers and chassis'.

5. The computer system of claim 1 wherein said database comprises data fields that comprise shipping device specifications including length, width, weight, fitting types, storage container types, chassis types, and serial numbers.

6. The computer system of claim 1 wherein said database comprises data fields indicating a location of a shipping device.

7. The computer system of claim 1 wherein each of said participants has a standard carrier alpha code.

8. A method for transferring control, liability and usage of a shipping device that is remotely located from a staging area between different participating parties, said method optimizes use of the shipping device by allowing participating parties to street-turn a shipping device, said method comprising:
entering data relating to the shipping device into a control database, said data comprising at least identification indicia for each shipping device, availability of each shipping device and location of each shipping device;
allowing remote access to the control database by participating parties;
providing a participating party with a list of all shipping devices that were interchanged away from the staging area and which are under the control of said participating party;
posting a particular shipping device by changing the availability of the particular shipping device in the control database when the particular shipping device is empty;
searching through the control database in an attempt to identify a shipping device having at least one desired characteristic;
contacting a participating party that posted the particular shipping device;
arranging for transfer of control of the particular shipping device from the participating party that posted the particular shipping device;
transferring control of the particular shipping device; and,
updating the control database to show that the particular shipping device is no longer available for use.

9. The method of claim 8 further comprising:
periodically updating the control database to reflect changes in a status of each shipping device.

10. The method of claim 8 further comprising:
providing a listing of available shipping devices, said listing including a length, width, weight, fitting type, storage container type, chassis type and serial number.

11. An apparatus for street-turning a shipping device, said apparatus comprising:
a plurality of participants;
a plurality of shipping devices, each shipping device having a length, width, weight, fitting type, and serial number;
a central controller having a database having a plurality of data fields, at least one of said data fields including identification indicia corresponding to each shipping device including a first information data field for individually identifying each shipping device and at least one of said data fields including an availability status of each shipping device; and,
a network connected between said plurality of participants and the central controller;
wherein apparatus allows transferring control, liability and usage of a shipping device that is remotely located from a staging area between different participants to prevent an inefficient use of the shipping device by allowing participants to street-turn the shipping device.

12. The apparatus of claim 11 further comprising a plurality of computers linked to the network for inputting data that changes the availability of each shipping container.

13. The apparatus of claim 11 wherein said participants comprise one or more selected from a group consisting of: ocean carriers, motor carriers, depot operators, leasing companies, and chassis pool operators.
